(19) United States
(12) Patent Application Publication
(10) Pub. No.: US 2015/0177533 A1
(43) Pub. Date: Jun. 25, 2015

(54) OPTICAL DEVICE, OPTICAL APPARATUS, AND METHOD FOR MANUFACTURING OPTICAL DEVICE

(71) Applicant: Asahi Glass Company, Limited, Chiyoda-ku (JP)

(72) Inventor: Kensuke ONO, Chiyoda-ku (JP)

(73) Assignee: Asahi Glass Company, Limited, Chiyoda-ku (JP)

(21) Appl. No.: 14/638,580

(22) Filed: Mar. 4, 2015

Related U.S. Application Data
(63) Continuation of application No. PCT/JP2013/072878, filed on Aug. 27, 2013.

(30) Foreign Application Priority Data
Sep. 5, 2012 (JP) 2012-195495

(51) Int. Cl. G02B 27/58; G02B 5/20; B29D 11/00; H04N 5/238; B29C 35/08; H04N 5/225; G02B 1/04

(52) U.S. Cl. CPC G02B 27/58; H04N 5/2254; G02B 5/205; G02B 1/04; H04N 5/238; B29C 35/0805; B29D 11/00653

(57) ABSTRACT

An optical device for monotonously reducing light transmittance from a center portion thereof to a peripheral portion thereof. The optical device includes an absorbing material part formed of a material that can absorb light and having a thickness monotonously increasing from the center portion to the peripheral portion, and a transparent material part formed of a material that can transmit light and stacked on the absorbing material part. A value of a refractive index of the absorbing material part and a value of a refractive index of the transparent material part are different.

### CROSS-REFERENCE TO RELATED APPLICATION

This application is a U.S. continuation application filed under 35 USC 111(a) claiming benefit under 35 USC 120 and 365(c) of PCT application JP2013/072878, filed Aug. 27, 2013, which claims priority to Application Ser. No. 2012-195495, filed in Japan on Sep. 5, 2012. The foregoing applications are hereby incorporated herein by reference.

### TECHNICAL FIELD

The present invention relates to an optical device, an optical apparatus, and a method for manufacturing an optical device.

### BACKGROUND ART

Optical devices, such as diaphragms and ND (Neutral Densities) filters, are used in cameras or other optical apparatuses for adjusting the amount of light incident on a lens or the like. Because mobile phones and portable terminals are also being equipped with cameras, diaphragms are provided in the cameras. A typical diaphragm is illustrated in FIG. 1. A diaphragm 910 is formed of a plate-like light shielding material having an opening 911 at its center portion. A peripheral portion of the diaphragm 910 surrounding the opening 911 blocks light whereas the center part of the diaphragm 910 formed with the opening 911 transmits light. In FIG. 1, (a) illustrates a plan view of the diaphragm 910, and (b) illustrates the transmittance of light for an area indicated with a dash-dot line 1A-1B of (a) of FIG. 1. In recent years, the sizes of cameras are becoming smaller along with the size-reduction and thickness-reduction of mobile phones and portable terminals. Therefore, the sizes of diaphragms are also becoming smaller. However, the diffraction of light at the peripheral portion surrounding the opening 911 cannot be ignored for a small-sized diaphragm 910. Thus, it is becoming more difficult to increase resolution for the small-sized diaphragm 910. That is, there is a desire for a small-sized diaphragm that can facilitate the increase of pixels of cameras while preventing resolution from degrading.

### PRIOR ART DOCUMENT

### Patent Document

### Patent Document 1: Japanese Laid-Open Patent Publication No. 2006-301221

### Patent Document 2: Japanese Registered Patent No. 3768858

### Patent Document 3: Japanese Registered Patent No. 4164355

### DISCLOSURE OF THE INVENTION

### Problems to be Solved by the Invention

In view of the above-described problem, an object of an embodiment of the present invention is to provide an optical device that can gradually reduce light transmittance from its center portion to its peripheral portion and provide satisfactory optical characteristics.

### Means of Solving the Problems

In order to achieve the above-described object, an embodiment of the present invention provides an optical device for monotonously reducing light transmittance from a center portion thereof to a peripheral portion thereof. The optical device includes an absorbing material part formed of a material that can absorb light and having a thickness monotonously increasing from the center portion to the peripheral portion, and a transparent material part formed of a material that can transmit light and stacked on the absorbing material part. A value of a refractive index of the absorbing material part and a value of a refractive index of the transparent material part are different.

According to another aspect, an embodiment of the present invention provides a method for manufacturing an optical device including the steps of forming an absorbing material part including a concave part by applying a droplet of a light absorbing resin in a mold having a convex-shaped center portion and curing the light absorbing resin, and forming a transparent material part in the concave part by applying a droplet of a transparent resin to the concave part and curing the transparent resin. The absorbing material part and the transparent material part are formed of a photo-polymerizable organic material or a thermally polymerizable organic material. A refractive index of the transparent material part is higher than a refractive index of the absorbing material part.

According to another aspect, an embodiment of the present invention provides a method for manufacturing an optical device including the steps of forming a transparent material part by applying a droplet of a transparent resin in a mold having a concave-shaped center portion and curing the transparent resin, and forming an absorbing material part by applying a droplet of a light absorbing resin onto the transparent material part and curing the light absorbing resin. The absorbing material part and the transparent material part are formed of a photo-polymerizable organic material or a thermally polymerizable organic material. A refractive index of the transparent material part is lower than a refractive index of the absorbing material part.

### Effects of the Invention

According to an embodiment of the present invention, there can be provided an optical device that can gradually reduce light transmittance from its center portion to its peripheral portion and provide satisfactory optical characteristics.

### BRIEF DESCRIPTION OF DRAWINGS

FIG. 1 is an explanatory diagram illustrating a conventional diaphragm;

FIG. 2 is a schematic diagram illustrating a structure of an optical device (apodizing filter);

FIG. 3 is a schematic diagram illustrating steps of a method for manufacturing the optical device illustrated in FIG. 2 (part 1);

FIG. 4 is a schematic diagram illustrating steps of a method for manufacturing the optical device illustrated in FIG. 2 (part 2);

FIG. 5 is a schematic diagram illustrating steps of a method for manufacturing the optical device illustrated in FIG. 2 (part 3);

FIG. 6 is an explanatory diagram illustrating an interference fringe created in the optical device illustrated in FIG. 2;

FIG. 7 is a schematic diagram illustrating a structure of an optical device according to a first embodiment of the present invention;

FIG. 8 is an explanatory diagram illustrating the optical device of the first embodiment (part 1);

FIG. 9 is an explanatory diagram illustrating the optical device of the first embodiment (part 2);

FIG. 10 is a schematic diagram illustrating steps of a method for manufacturing the optical device of the first embodiment (part 1);

FIG. 11 is a schematic diagram illustrating steps of a method for manufacturing the optical device of the first embodiment (part 2);

FIG. 12 is a schematic diagram illustrating steps of a method for manufacturing the optical device of the first embodiment (part 3);

FIG. 13 is an explanatory diagram illustrating an interference fringe created in the optical device of the first embodiment;

FIG. 14 is a schematic diagram illustrating a structure of an imaging apparatus of the first embodiment;

FIG. 15 is a schematic diagram illustrating a structure of an optical device according to a second embodiment of the present invention;

FIG. 16 is a schematic diagram illustrating steps of a method for manufacturing the optical device of the second embodiment (part 1);

FIG. 17 is a schematic diagram illustrating steps of a method for manufacturing the optical device of the second embodiment (part 2);

FIG. 18 is a schematic diagram illustrating steps of a method for manufacturing the optical device of the second embodiment (part 3);

FIG. 19 is a schematic diagram illustrating a structure of an optical device according to a third embodiment of the present invention;

FIG. 20 is a schematic diagram illustrating steps of a method for manufacturing the optical device of the third embodiment (part 1);

FIG. 21 is a schematic diagram illustrating steps of a method for manufacturing the optical device of the third embodiment (part 2);

FIG. 22 is a schematic diagram illustrating steps of a method for manufacturing the optical device of the third embodiment (part 3);

FIG. 23 is a schematic diagram illustrating steps of a method for manufacturing the optical device of the third embodiment (part 4);

FIG. 24 is an explanatory diagram illustrating an interference fringe created in the optical device of the third embodiment;

FIG. 25 is a schematic diagram illustrating steps of a method for manufacturing an optical device according to a fourth embodiment of the present invention (part 1);

FIG. 26 is a schematic diagram illustrating steps of a method for manufacturing the optical device of the fourth embodiment (part 2);

FIG. 27 is a schematic diagram illustrating steps of a method for manufacturing the optical device of the fourth embodiment (part 3);

FIGS. 28A and 28B are explanatory diagrams illustrating smartphones mounted with an optical apparatus according to a fifth embodiment of the present invention; and

FIG. 29 is an explanatory diagram illustrating the optical apparatus of the fifth embodiment.

### EMBODIMENTS FOR CARRYING OUT THE INVENTION

Next, embodiment of the present invention are described with the accompanying drawings. It is to be noted that like components and parts are denoted with like reference numerals and further explanation thereof may be omitted.

### First Embodiment

First, an example of an optical filter 1 that gradually reduces light transmittance from its center portion to its peripheral portion (so-called “apodizing filter”) is described.

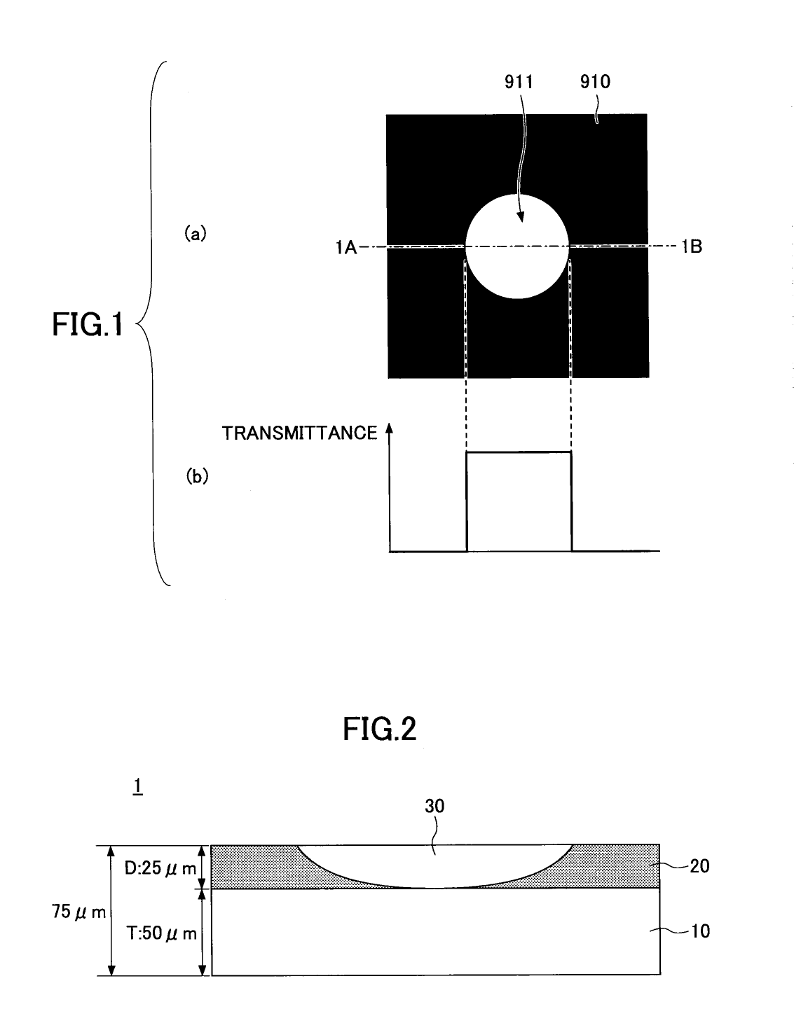

As illustrated in FIG. 2, the optical device 1 includes a transparent substrate 10. An absorbing material part 20 formed of a material absorbing visible light and a transparent material part 30 formed of a material transmitting visible light are provided on the transparent substrate 10. In the optical device 1, the refractive index of the absorbing material part 20 and the refractive index of the transparent material part 30 are substantially the same. For example, the optical device 1 may be formed, so that the difference of refractive indices between the absorbing material part 20 and the transparent material part 30 is less than or equal to 0.001.

The absorbing material part 20 has a concave shape. The absorbing material part 20 is formed with a thickness that gradually increases from its center portion to its peripheral portion. By forming the absorbing material part 20 with a thickness that gradually increases from its center portion to its peripheral portion, the amount of light transmitted through the absorbing material part 20 can be gradually reduced from its center portion to its peripheral portion. That is, the light transmittance of the absorbing material part 20 can be gradually reduced from its center portion to its peripheral portion.

The transparent material part 30 is formed to fill the concave portion of the absorbing material part 20. Further, the transparent substrate 10 is formed of a transparent resin material (e.g., PET (Polyethyline terephthalate)) that transmits visible light. In a case where the optical device 1 is used for a camera part of a mobile phone or the like, the optical device 1 is desired to be thinly formed. Thus, the optical device 1 is formed having a total thickness that is less than or equal to 200 μm. For example, the total thickness of the optical device 1 is approximately 75 μm in which the thickness T of the transparent substrate 10 is approximately 50 μm and the thickness D of the thickest part of the absorbing material part 20 is approximately 25 μm. It is to be noted that, in the specification, the term “visible light” refers to light having a wavelength ranging from 380 nm to 800 nm.

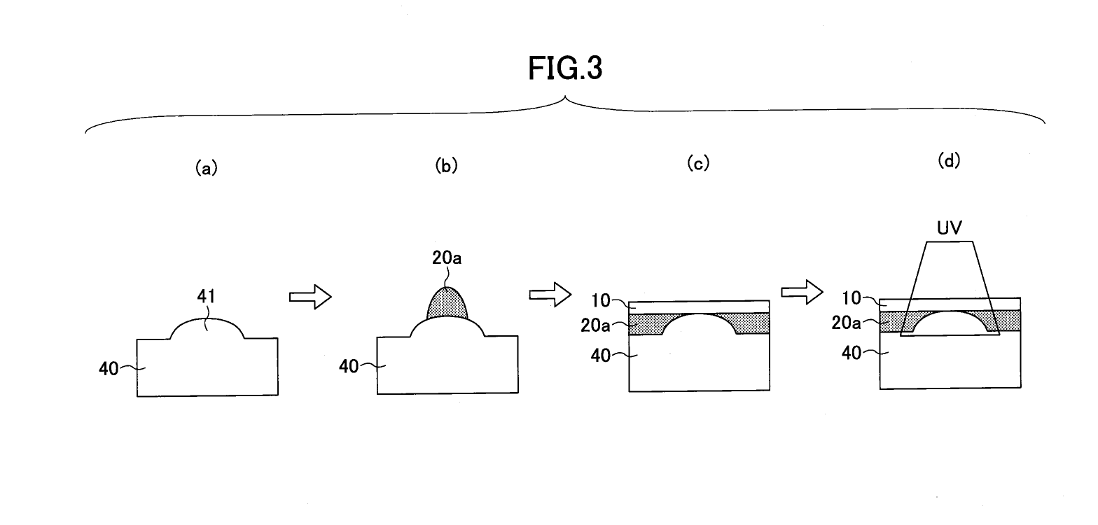

Next, an example of a method for manufacturing the optical device 1 is described with reference to FIGS. 3 to 5. The value of the refractive index in the following example is a refractive index relative to light having a wavelength of 405 nm.

First, as illustrated in (a) of FIG. 3, a mold 40 for forming the absorbing material part 20 is prepared. A convex part 41 having a height of, for example, 27 μm is formed in a center portion of the mold 40. The convex part 41 has a shape corresponding to the concave shape of the absorbing material part 20 to be formed. Further, the entire material of the mold 40 may be, for example, stainless steel. An NiP plating may be formed on the front surface of the mold 40.

Then, as illustrated in (b) of FIG. 3, a droplet of a light absorbing resin 20a for forming the absorbing material part 20 is applied to the mold 40. The light absorbing resin 20a is formed of a light absorbing material that can be cured by being radiated by ultraviolet (UV) light. The light absorbing resin 20a may include a black material such as black titanium oxide and carbon black.

Then, as illustrated in (c) of FIG. 3, the transparent substrate 10 is mounted on the droplet of the light absorbing resin 20a. The transparent substrate 10 may be, for example, Lumirror U32 (manufactured by Toray Co. Ltd.,) having a thickness of approximately 50 μm.

Then, as illustrated in (d) of FIG. 3, the light absorbing resin 20a is cured by radiating ultraviolet light from the side in which the transparent substrate 10 is mounted. Thereby, the absorbing material part 20 is formed. The ultraviolet light radiated in this step has a wavelength of 365 nm and an illumination power density of 300 mW/cm². The ultraviolet light is radiated for 200 seconds.

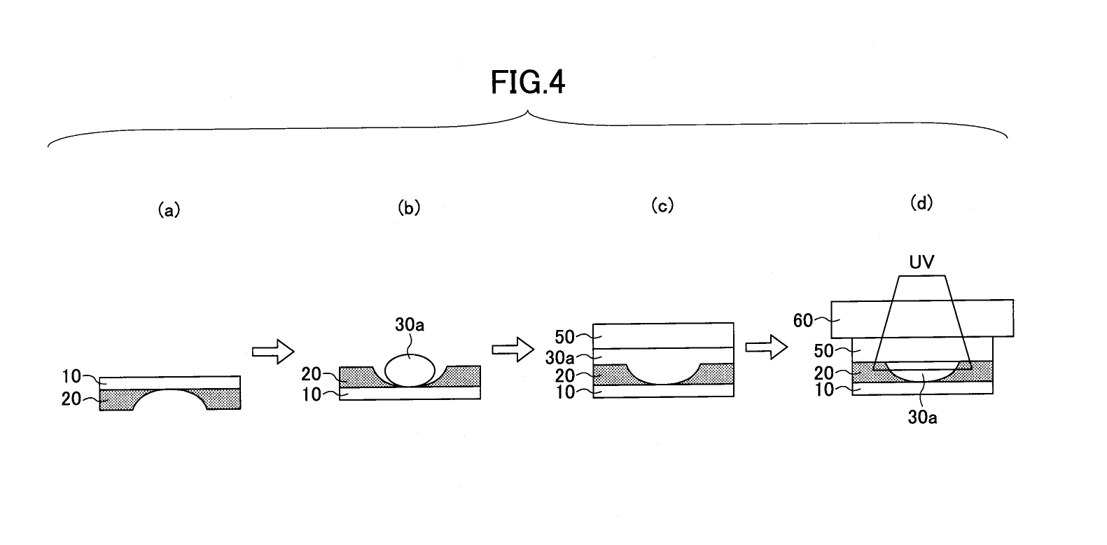

Then, as illustrated in (a) of FIG. 4, the mold 40 is separated from the transparent substrate 10 and the absorbing material part 20. Thereby, the transparent substrate 10 having a concave-shaped absorbing material part 20 formed thereon is obtained. It is to be noted that the absorbing material part 20 includes a light absorbing material such as black titanium oxide or carbon black. The refractive index of the absorbing material part 20 is, for example, 1.60.

Then, as illustrated in (b) of FIG. 4, a droplet of a transparent resin 30a is applied on the concave-shaped portion of the absorbing material part 20. The transparent resin 30a is a resin material that can transmit light and be cured by being radiated with ultraviolet light. The transparent resin 30a of this example has a shrinkage rate of approximately 6%.

Then, as illustrated in (c) of FIG. 4, a release substrate 50 is mounted on the droplet of the transparent resin 30a. The release substrate 50 is formed of, for example, quartz. The front surface of the release substrate 50 has fluorine applied, so that the release substrate 50 can easily be released in a subsequent process.

Then, as illustrated in (d) of FIG. 4, ultraviolet light is radiated to the transparent resin 30a in a state where pressure is exerted from a press machine having a quartz window 60 by way of the release substrate 50. As for the conditions for this step, the exerted pressure is approximately 0.5 MPa, the radiated ultraviolet light has a wavelength of 365 nm and an illumination power density of 300 mW/cm². The ultraviolet light is radiated for 30 seconds.

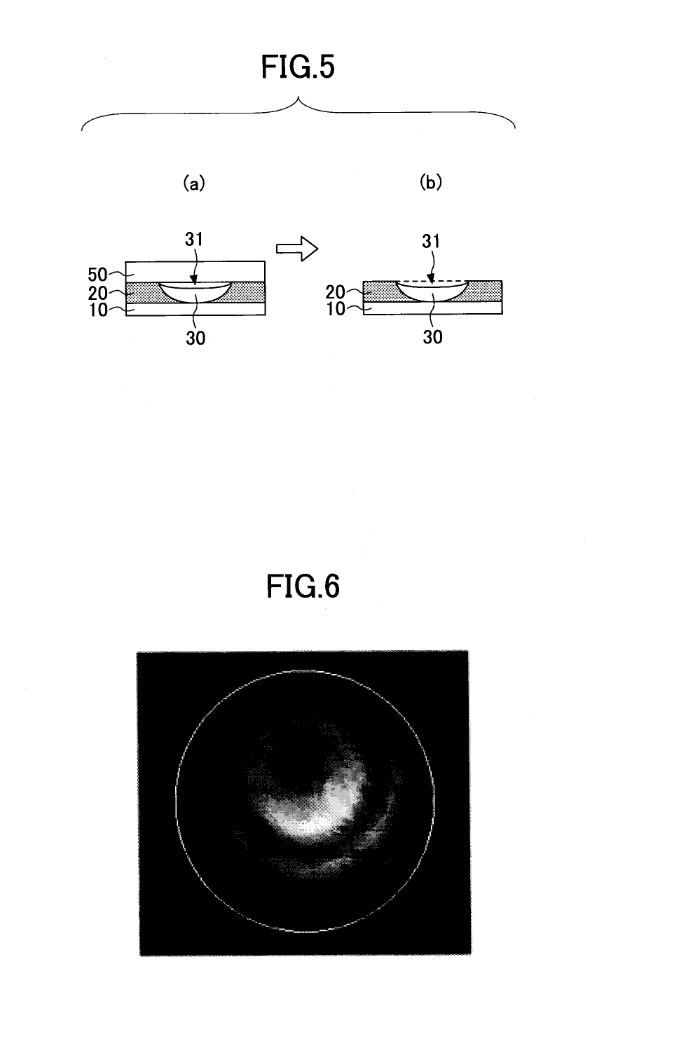

By the radiating ultraviolet light in the state where pressure is exerted, the transparent resin 30a is cured, so that the transparent material part 30 is formed. Because the transparent resin 30a shrinks during this process, a center portion of the transparent material part 30 becomes recessed in correspondence to the concave shape of the absorbing material part 20. Thereby, the transparent material part 30 is formed having a concave part 31 as illustrated in (a) of FIG. 5. The refractive index of the transparent material part 30 is, for example, 1.60.

Then, as illustrated in (b) of FIG. 5, the release substrate 50 is released. Thereby, the optical device 1 is fabricated. The thickness of the entire optical device 1 is approximately 75 μm. The concave part 31 formed at the center portion on the front surface of the transparent material part 30 has a depth of a few μm. The optical device 1 has a transmitted wavefront precision of, for example, 1.82λ relative to light having a wavelength of 405 nm. Thus, as illustrated in FIG. 6, many interference fringes are created with the optical device 1.

### <Optical Device>

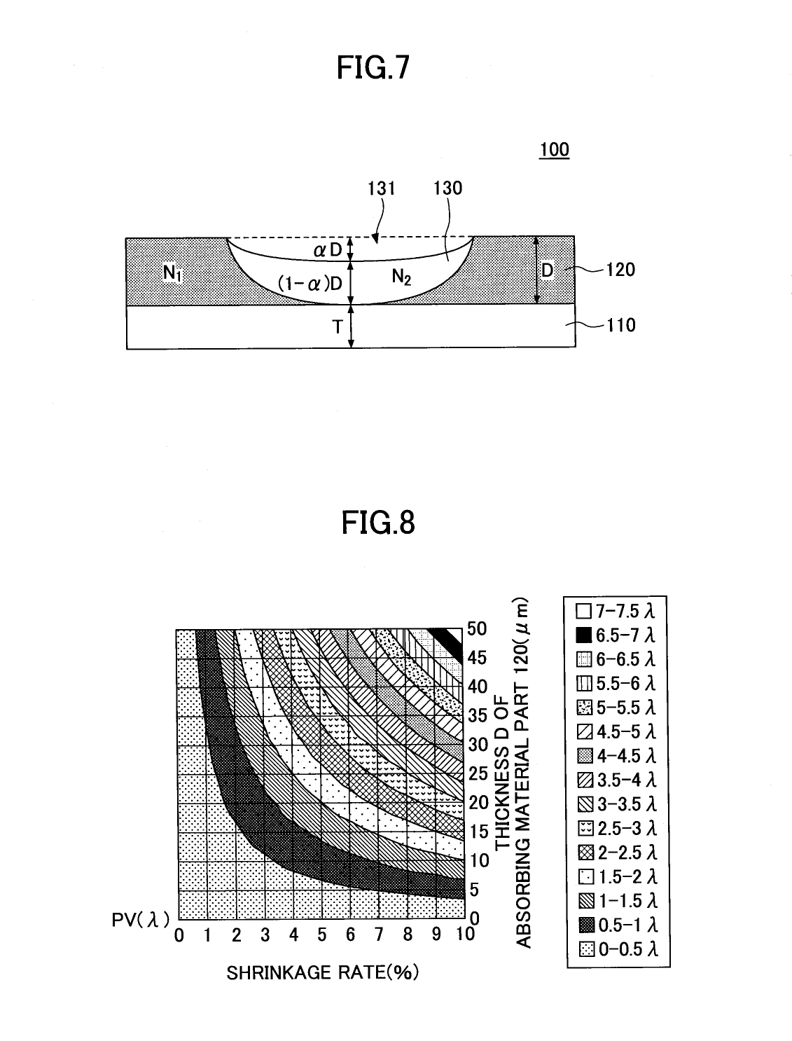

Next, an optical device 100 according to a first embodiment of the present invention is described. The optical device 100 of the first embodiment is an optical filter that gradually reduces light transmittance from its center portion to its peripheral portion (so-called “apodizing filter”). As illustrated in FIG. 7, the optical device 100 includes a transparent substrate 110. An absorbing material part 120 that is formed of a material that absorbs visible light and a transparent material part 130 that is formed of a material that transmits visible light are provided on the transparent substrate 110. More specifically, the absorbing material part 120 and the transparent material part 130 are stacked on the transparent substrate 110. The optical device 100 of this embodiment may be an optical device that can monotonously reduce light transmittance from its center portion to its peripheral portion.

The absorbing material part 120 has a concave shape. The absorbing material part 120 is formed with a thickness that gradually increases from its center portion to its peripheral portion. By forming the absorbing material part 120 with a thickness that gradually increases from its center portion to its peripheral portion, the amount of light transmitted by the absorbing material part 20 can be gradually reduced from its center portion to its peripheral portion. That is, the light transmittance of the absorbing material part 120 can be gradually reduced from its center portion to its peripheral portion.

The transparent material part 130 is formed to fill the concave portion of the absorbing material part 120. Further, the transparent substrate 110 is formed of a transparent resin material (e.g., PET (Polyethyline terephthalate)) that transmits visible light. In a case where the optical device 100 is used for a camera part of a mobile phone or the like, the optical device 100 is desired to be thinly formed. Thus, the optical device 100 is formed having a total thickness that is less than or equal to 200 μm. For example, the total thickness of the optical device 100 is approximately 75 μm in which the thickness T of the transparent substrate 110 is approximately 50 μm and the thickness D of the thickest part of the absorbing material part 120 is approximately 25 μm.

The thickness of the thinnest part of the transparent material part 130 is approximately less than or equal to 0.5 μm. Thus, the thickness of the thinnest part of the transparent material part 130 is significantly less than the thickness of the thickest part of the absorbing material part 120. Because the thickness of the transparent material part 130 is defined according to the pressure exerted during a curing process and the viscosity coefficient of the transparent resin 30a before being cured, the transparent material part 130 is to be, for example, a resin having a low viscosity coefficient (less than or equal to 1 Pa·s).

The optical device 100 of this embodiment is formed, so that the value of the refractive index N₁ of the absorbing material part 120 and the value of the refractive index N₂ of the transparent material part 130 are different. Further, assuming “α” is the shrinkage of the transparent resin used for forming the transparent resin part 130, the thickness of the transparent material part 130 at the center portion of the optical device 100 (i.e., thickness of the thickest part of the transparent material part 130) is expressed as “(1−α) D” in a case where “D” is the thickness of the thickest part of the absorbing material part 120. Therefore, the depth of the concave part 131 formed in the front surface of the transparent material part 130, that is, the depth of the deepest part of the concave part 131 relative to its front surface is expressed as “αD”.

FIG. 8 illustrates aberration occurring with respect to light having a wavelength of 405 nm in relation with the shrinkage rate α of the transparent resin used for forming the transparent material part 130 and the thickness D of the absorbing material part 120. It is to be noted that the thickness of the thinnest part of the concave-shaped absorbing material part 120 is approximately 0 μm (e.g., approximately less than or equal to 0.2 μm).

The optical device 100 is preferred to have a low phase difference with respect to light having a predetermined wavelength λ throughout the entire optical device 100. For example, the phase difference of the optical device 100 is preferred to be less than or equal to λ/2. Because the optical device 100 of this embodiment is used throughout the entire visible light range, the light having the predetermined wavelength 1 is assumed to be a wavelength that is near the shortest wavelength of the visible light region (e.g., 405 nm). The shrinkage rate α of the resin material (e.g., UV curing resin) used for forming the transparent material part 130 typically ranges from 3% to 10%. Under a circumstance where an imprinting method is used to form the absorbing material part 120, the lower limit of the thickness of the absorbing material part 120 is approximately 15 μm. Although increasing the light absorbing coefficient of the light absorbing material 120a is important for reducing the thickness of the absorbing material part 120 while maintaining optical characteristics, manufacturing the absorbing material part 120 less than 15 μm is difficult because the margin becomes lower with respect to the variability of the thickness of the light absorbing material.

Because the phase difference is preferred to be less than or equal to λ/2, the following expression (1) is derived.

|αD+N₂(1−α)D−N₁D|<λ/2 <Expression (1)>

Further, assuming that “3%<α<10%”, “15 μm<D<50 μm” and “N₂” is approximately 1.6, the range of “|N′−N₂|” is expressed with the following expression (2).

0.018−λ/2D<|N₁−N₂|<0.06+λ/2D <Expression (2)

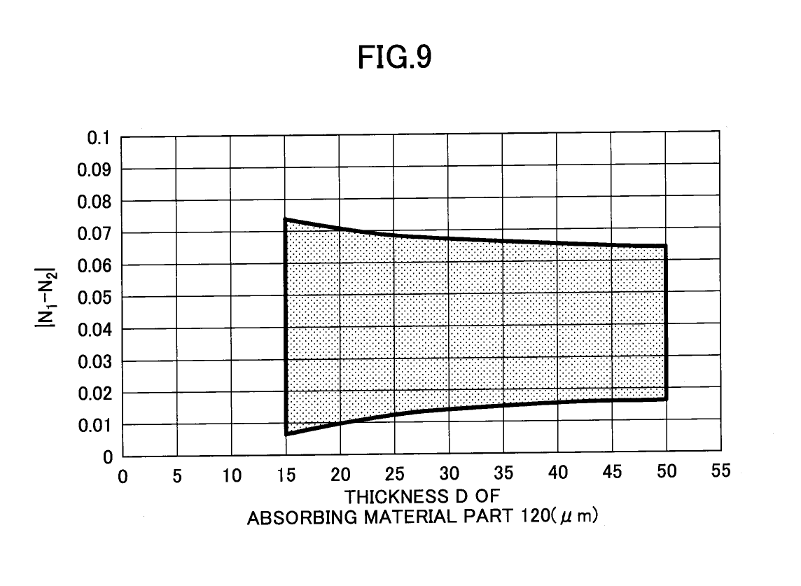

FIG. 9 illustrates a relationship between the thickness D of the absorbing member part 120 and the value “|N₁−N₂|” of the Expression (2).

Accordingly, the optical device 100 of the first embodiment is formed, so that the phase difference of the entire optical device 100 is less than or equal to λ/2. More specifically, the optical device 100 of the first embodiment is formed to satisfy the above-described expression (2) in a case where “15 μm<D<50 μm.

### <Method for Manufacturing Optical Device>

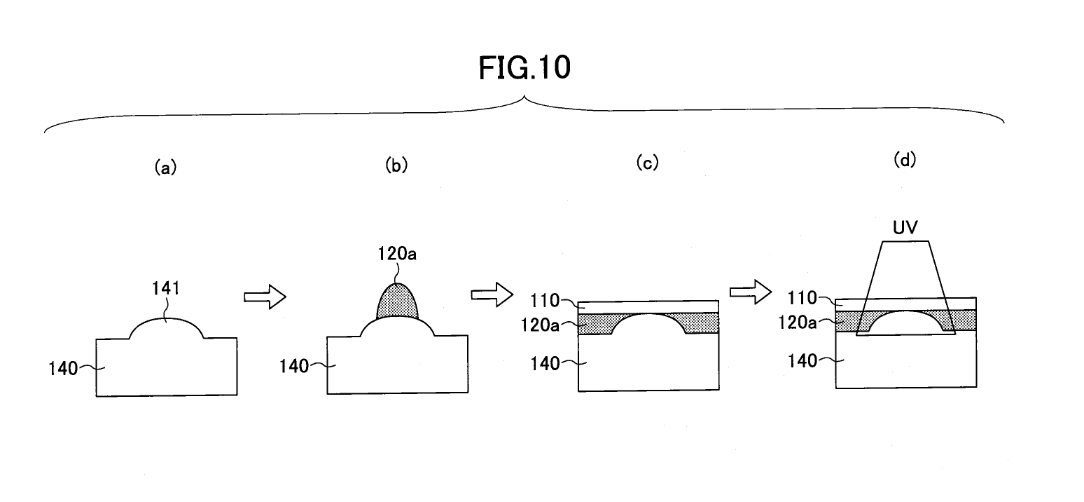

Next, a method for manufacturing an optical device 100 according to the first embodiment is described with reference to FIGS. 10 to 12. In the optical device 100, the refractive index N₂ of the transparent material part 130 is higher than the refractive index N₁ of the absorbing material part 120. It is to be noted that the refractive index of the below-described embodiment is the refractive index relative to light having a wavelength of 405 nm.

First, as illustrated in (a) of FIG. 10, a mold 140 for forming the absorbing material part 120 is prepared. A convex part 141 having a height of, for example, 27 μm is formed in a center portion of the mold 140. The convex part 141 has a shape corresponding to the concave shape of the absorbing material part 120 to be formed. Further, the entire material of the mold 140 may be, for example, stainless steel. An NiP plating may be formed on the front surface of the mold 140.

Then, as illustrated in (b) of FIG. 10, a droplet of a light absorbing resin 120a for forming the absorbing material part 120 is applied to the mold 140. The light absorbing resin 120a is formed of a light absorbing material that can be cured by being radiated by ultraviolet (UV) light. The light absorbing resin 120a may include a black material such as black titanium oxide and carbon black.

Then, as illustrated in (c) of FIG. 10, the transparent substrate 110 is mounted on the droplet of the light absorbing resin 120a. The transparent substrate 110 may be, for example, Lumirror U32 (manufactured by Toray Co. Ltd.,) having a thickness of approximately 50 μm.

Then, as illustrated in (d) of FIG. 10, the light absorbing resin 120a is cured by radiating ultraviolet light from the side on which the transparent substrate 110 is mounted. Thereby, the absorbing material part 120 is formed. The ultraviolet light radiated in this step has a wavelength of 365 nm and an illumination power density of 300 mW/cm². The ultraviolet light is radiated for 200 seconds.

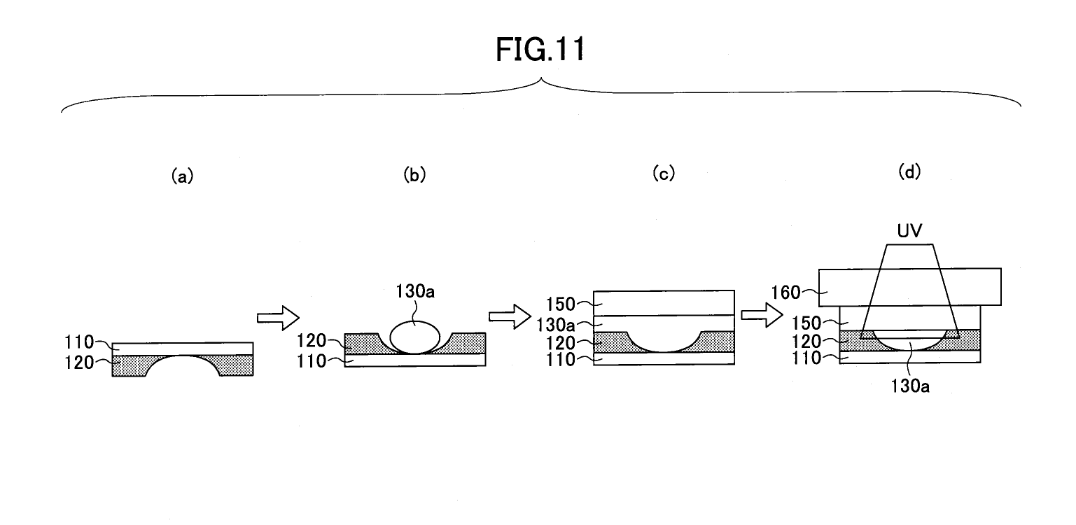

Then, as illustrated in (a) of FIG. 11, the mold 140 is separated from the transparent substrate 110 and the absorbing material part 120. Thereby, the transparent substrate 110 having a concave-shaped absorbing material part 120 formed thereon is obtained. It is to be noted that the absorbing material part 120 includes a light absorbing material such as black titanium oxide or carbon black. The refractive index of the absorbing material part 120 is, for example, 1.60.

Then, as illustrated in (b) of FIG. 11, a droplet of a transparent resin 130a is applied on the concave-shaped portion of the absorbing material part 120. The transparent resin 130a is a resin material that can transmit light and be cured by being radiated with ultraviolet light.

Then, as illustrated in (c) of FIG. 11, a release substrate 150 is mounted on the droplet of the transparent resin 130a. The release substrate 150 is formed of, for example, quartz. The front surface of the release substrate 150 has fluorine applied, so that the release substrate 150 can easily be released in a subsequent process.

Then, as illustrated in (d) of FIG. 11, ultraviolet light is radiated to the transparent resin 130a in a state where pressure is exerted from a press machine having a quartz window 160 by way of the release substrate 150. As for the conditions for this step, the exerted pressure is approximately 0.5 MPa, and the radiated ultraviolet light has a wavelength of 365 nm and an illumination power density of 300 mW/cm². The ultraviolet light is radiated for 30 seconds.

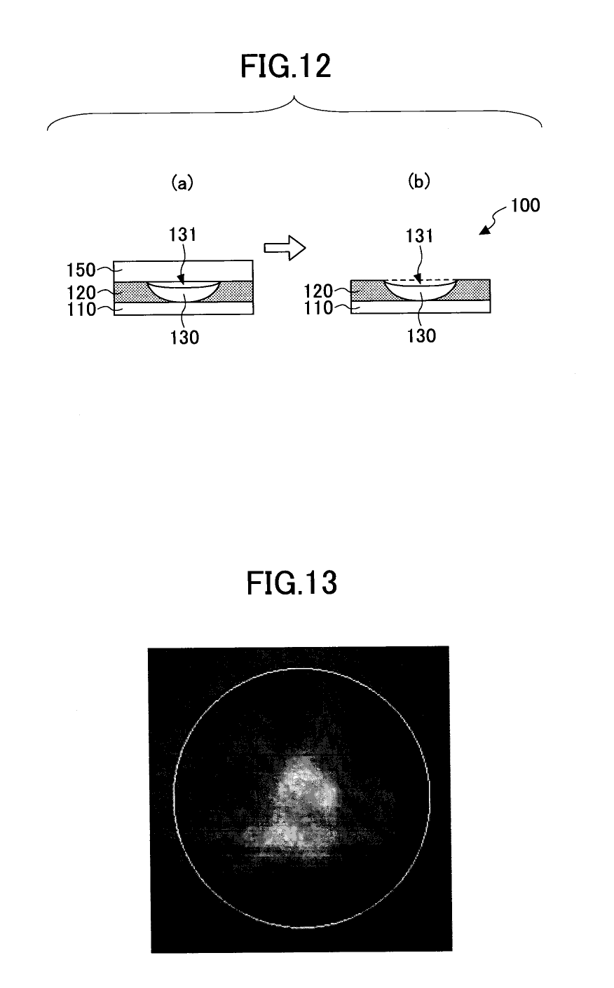

By the radiating ultraviolet light in the state where pressure is exerted, the transparent resin 130a is cured, so that the transparent material part 130 is formed. Because the transparent resin 130a shrinks during this process, a center portion of the transparent material part 130 becomes recessed in correspondence to the concave shape of the absorbing material part 120. Thereby, the transparent material part 130 is formed having a concave part 131 as illustrated in (a) of FIG. 12. The refractive index of the transparent material part 130 is, for example, 1.65.

Then, as illustrated in (b) of FIG. 12, the release substrate 150 is released. Thereby, the optical device 100 is fabricated. The thickness of the entire optical device 100 is approximately 75 μm. The concave part 131 formed at the center portion on the front surface of the transparent material part 130 has a depth of a few μm. The optical device 100 has a transmitted wavefront precision of 0.48λ relative to light having a wavelength of 405 nm. Thus, as illustrated in FIG. 13, hardly any circumferential interference fringes are created with the optical device 100. For example, the transmitted wavefront precision of 0.48λ is mostly due to astigmatism or high-order aberration caused by warping or the like during the process of fabricating the optical device 100 and is not due to the left-hand side of the above-described expression (1).

In the above-described embodiment, the absorbing material part 120 and the transparent material part 130 are formed of a photo-polymerizable organic material such as a UV curable resin. Alternatively, the absorbing material part 120 and the transparent material part 130 may be formed of a thermally polymerizable organic material such as a thermally curable resin. Further, the refractive index of the transparent material part 130 is preferred to be greater than or equal to 1.45 and less than or equal to 1.70.

### <Imaging Apparatus>

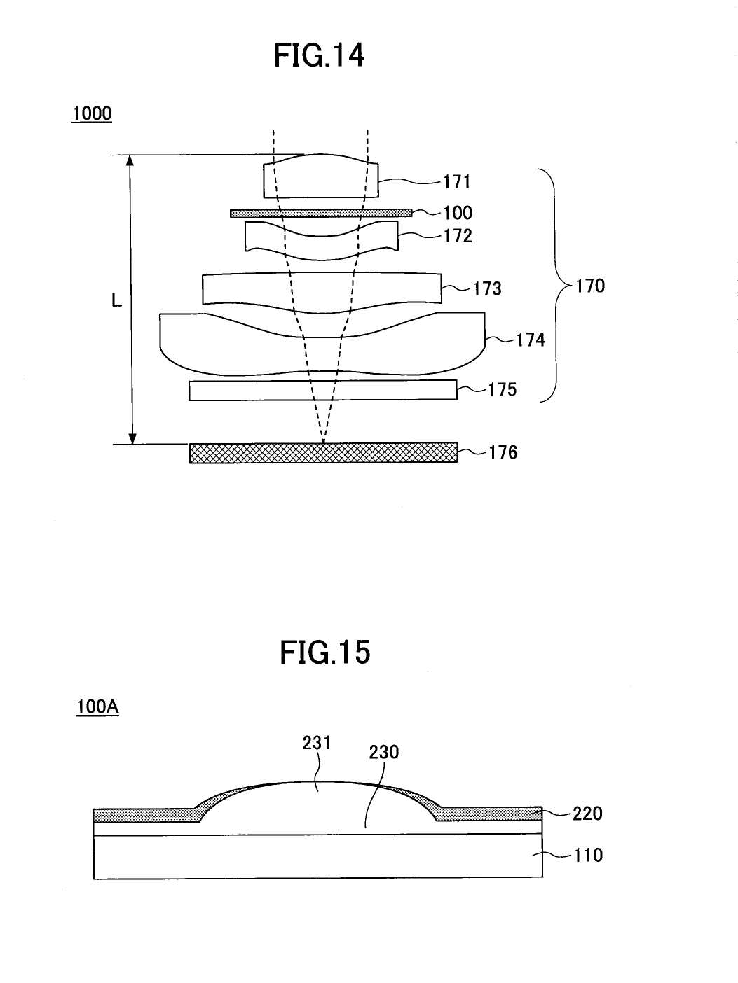

Next, an imaging device 1000 according to an embodiment of the present invention is described. As illustrated in FIG. 14, the imaging device 1000 includes, for example, the optical device (apodizing filter) 100, four lenses 171, 172, 173, 174, an imaging device luminous sensitivity correction filter 175, and an imaging device 176 including a CMOS sensor. When taking an image (imaging) with the imaging device 1000, light incident on the imaging device 1000 is transmitted through the optical device 100 via the lens 171, and then becomes incident on the imaging device 176 via the lenses 172-174 and the imaging device luminous sensitivity correction filter 175. In a camera part of a mobile phone or the like, a length L from the lens 171 to the imaging device 176 is desired to be short. Because the optical device 100 of this embodiment can be thinly formed, the length L from the lens 171 and the imaging device 176 can be short. The below-described optical system 170 according to an embodiment of the present invention may include the optical device (apodizing filter) 100, the four lenses 171-174, and the imaging device luminous sensitivity correction filter 175.

### Second Embodiment

### Optical Device

Next, an optical device 100A according to a second embodiment of the present invention is described. The optical device 100A of the second embodiment is an optical filter that gradually reduces light transmittance from its center portion to its peripheral portion (so-called “apodizing filter”). As illustrated in FIG. 15, the optical device 100A includes the transparent substrate 110. An absorbing material part 220 formed of a material absorbing visible light and a transparent material part 230 formed of a material transmitting visible light are provided on the transparent substrate 110.

The transparent material part 230 has a center portion formed to be a convex shape. The transparent material part 230 gradually becomes thinner from its center portion to its peripheral portion. The absorbing material part 220 is formed on the transparent material part 230. The absorbing material part 220 is formed, so that the thickness of the absorbing material part 220 gradually increases from its center portion to its peripheral portion in correspondence to the shape of the transparent material part 230. By forming the absorbing material part 220 to have a thickness that gradually increases from its center portion to its peripheral portion, the amount of light transmitted through the absorbing material part 220 can be gradually reduced from its center portion to its peripheral portion. That is, the transmittance of light can be gradually reduced from the center portion of the absorbing material part 220 to the peripheral portion of the absorbing material part 220.

### <Method for Manufacturing Optical Device>

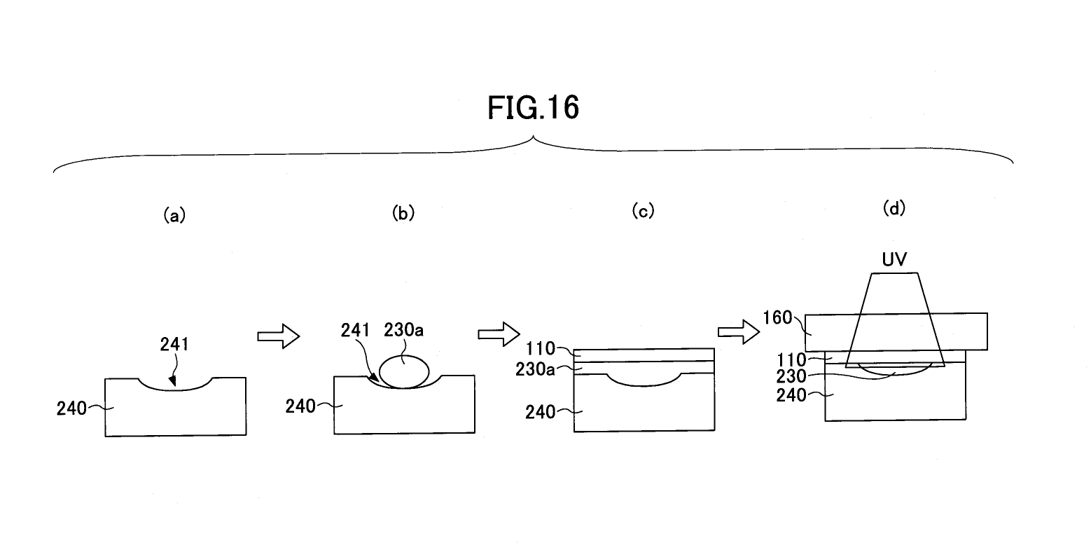

Next, a method for manufacturing an optical device 100A according to the second embodiment is described with reference to FIGS. 16 to 18. In the optical device 100A, the refractive index N₂ of the transparent material part 230 is lower than the refractive index N₁ of the absorbing material part 220. It is to be noted that the refractive index of the below-described embodiment is the refractive index relative to a light having a wavelength of 405 nm.

First, as illustrated in (a) of FIG. 16, a mold 240 for forming the absorbing material part 230 is prepared. A concave part 241 having a depth of, for example, 27 μm is formed in a center portion of the mold 240. The concave part 241 has a shape corresponding to the convex shape of the absorbing material part 230 to be formed. Further, the material of the mold 240 may be, for example, stainless steel. An NiP plating may be formed on the front surface of the mold 240.

Then, as illustrated in (b) of FIG. 16, a droplet of a transparent resin 230a is applied to the concave part 241 of the mold 240. The transparent resin 230a is formed of a light transmitting resin that can be cured by being radiated by ultraviolet (UV) light.

Then, as illustrated in (c) of FIG. 16, the transparent substrate 110 is mounted on the droplet of the transparent resin 230a. The transparent substrate 110 may be, for example, Lumirror U32 (manufactured by Toray Co. Ltd.,) having a thickness of approximately 50 μm.

Then, as illustrated in (d) of FIG. 16, ultraviolet light is radiated to the transparent resin 230a from the side on which the transparent substrate 110 is mounted in a state where pressure is exerted from a press machine having a quartz window 160. In this step, the exerted pressure is approximately 0.5 MPa, the radiated ultraviolet light has a wavelength of 365 nm and an illumination power density of 300 mW/cm². The ultraviolet light is radiated for 30 seconds.

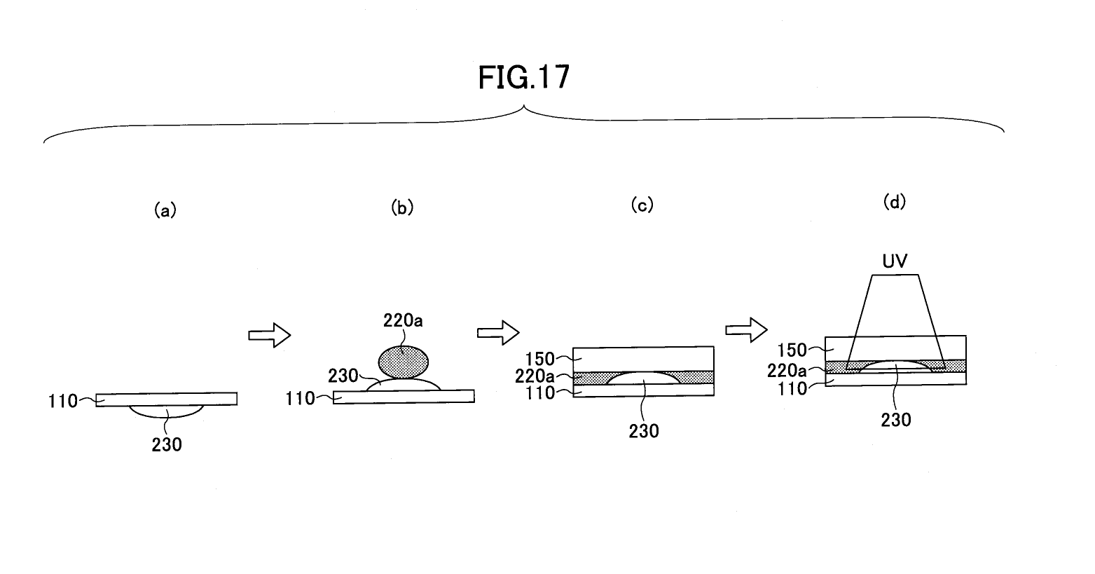

Then, as illustrated in (a) of FIG. 17, the mold 240 is separated from the transparent substrate 110 and the transparent material part 230. Thereby, the transparent substrate 110 having a convex-shaped transparent material part 230 formed thereon is obtained. The refractive index of the transparent material part 230 is, for example, 1.55.

Then, as illustrated in (b) of FIG. 17, a droplet of a light absorbing resin 220a for forming the absorbing material part 220 is applied on the transparent material part 230. The light absorbing resin 220a is a material that can absorb light and be cured by being radiated with ultraviolet light. The light absorbing resin 220a may include a black material such as black titanium oxide and carbon black. The light absorbing resin 220a of this embodiment has a shrinkage rate of approximately 6%.

Then, as illustrated in (c) of FIG. 17, a release substrate 150 is mounted on the droplet of the light absorbing resin 220a. The release substrate 150 is formed of, for example, quartz. The front surface of the release substrate 150 has fluorine applied, so that the release substrate 150 can easily be released in a subsequent process.

Then, as illustrated in (d) of FIG. 17, the light absorbing resin 220a is cured by radiating ultraviolet light from the side on which the release substrate 150 is mounted. Thereby, the absorbing material part 220 is formed. The ultraviolet light radiated in this step has a wavelength of 365 nm and an illumination power density of 300 mW/cm². The ultraviolet light is radiated for 200 seconds. It is to be noted that the absorbing material part 220 includes a light absorbing material such as black titanium oxide or carbon black. The refractive index of the absorbing material part 220 is, for example, 1.60.

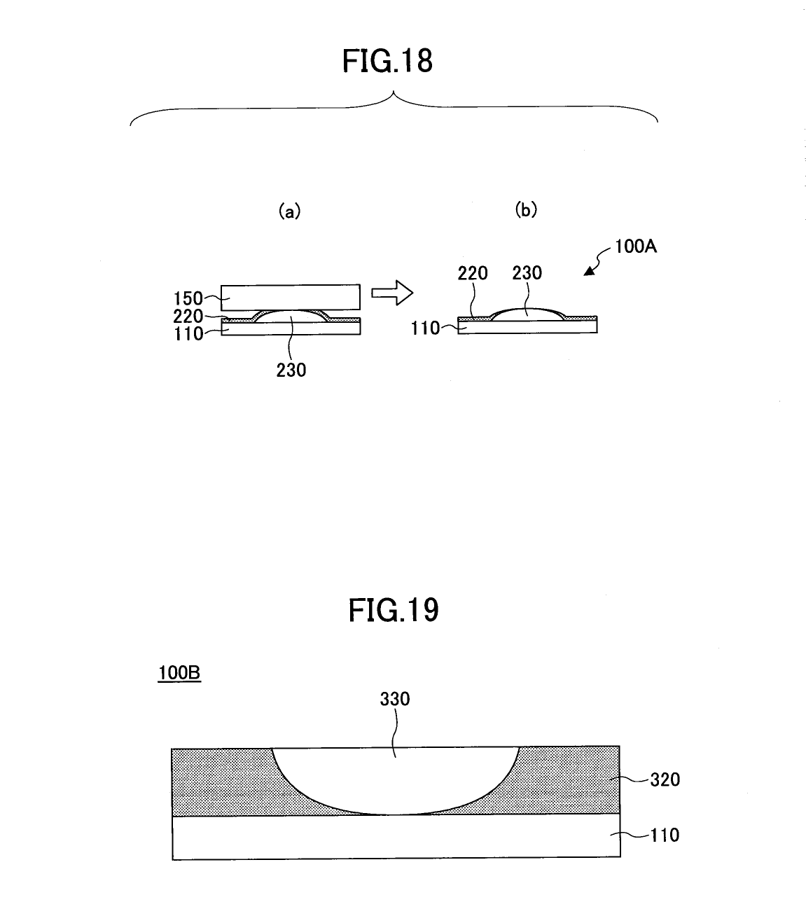

In the above-described manner, the absorbing material part 220 is formed by curing the light absorbing resin 220a with the radiation of ultraviolet light. Because the light absorbing resin 220a shrinks during the radiation, the absorbing material part 220 is formed, so that the peripheral portion of the optical device 100A is thinly formed in correspondence to the convex shape of the transparent material part 230 as illustrated in (a) of FIG. 18.

Then, as illustrated in (b) of FIG. 18, the release substrate 150 is released. Thereby, the optical device 100A is fabricated. Similar to the optical device 100 of the first embodiment, the optical device 100A can also attain satisfactory optical characteristics.

Except for the details described above, the second embodiment is substantially the same as the first embodiment. Further, the optical device 100A of the second embodiment can be applied to the imaging apparatus of the first embodiment.

### Third Embodiment

Next, an optical device 100B according to a third embodiment of the present invention is described. The optical device 100B of the third embodiment is an optical filter that gradually reduces light transmittance from its center portion to its peripheral portion (so-called “apodizing filter”). As illustrated in FIG. 19, the optical device 100B includes a transparent substrate 110. An absorbing material part 320 that is formed of a material that absorbs visible light and a transparent material part 330 that is formed of a material that transmits visible light are provided on the transparent substrate 110. In the optical device 100B, the refractive index of the absorbing material part 320 and the refractive index of the transparent material part 330 are substantially the same. For example, the difference of refractive indices between the absorbing material part 320 and the transparent material part 330 is less than or equal to 0.001. It is to be noted that the refractive index in the below-described embodiment is the refractive index relative to a light having a wavelength of 589 nm.

The absorbing material part 320 has a concave shape. The absorbing material part 320 is formed with a thickness that gradually increases from its center portion to its peripheral portion. By forming the absorbing material part 320 with a thickness that gradually increases from its center portion to its peripheral portion, the amount of light transmitted by the absorbing material part 320 can be gradually reduced from its center portion to its peripheral portion. That is, the light transmittance of the absorbing material part 320 can be gradually reduced from its center portion to its peripheral portion.

The transparent material part 330 is formed to fill the concave portion of the absorbing material part 320. The front surface of the transparent material part 330 is substantially flat. For example, the flatness of the front surface of the transparent material part 330 is less than or equal to 0.3 μm. The transparent substrate 110 is formed of a transparent resin material (e.g., PET (Polyethyline terephthalate)) that transmits visible light.

### <Method for Manufacturing Optical Device>

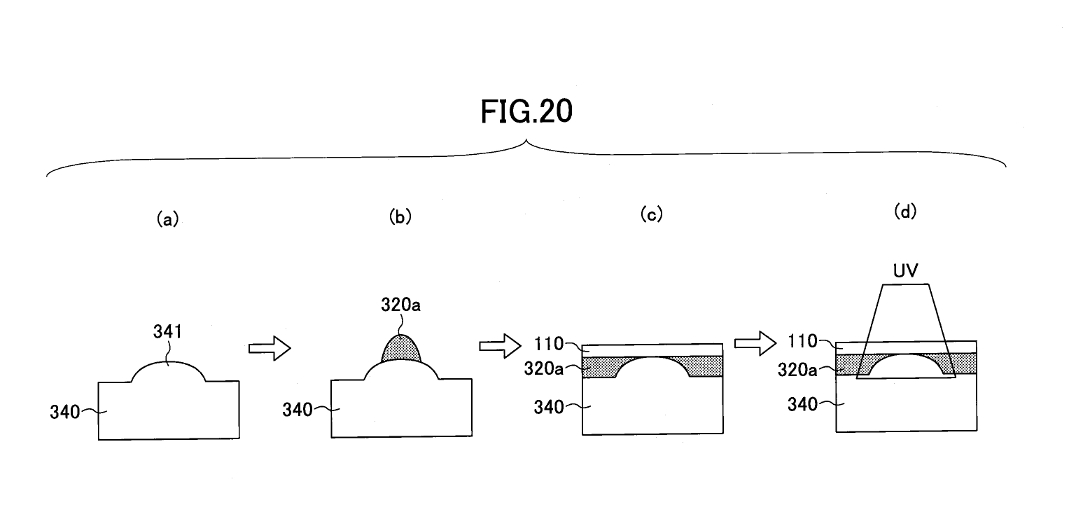

Next, a method for manufacturing the optical device 100B according to the third embodiment is described with reference to FIGS. 20 to 23. First, as illustrated in (a) of FIG. 20, a mold 340 for forming the absorbing material part 320 is prepared. A convex part 341 having a height of, for example, 27 μm is formed in a center portion of the mold 340. The convex part 341 has a shape corresponding to the concave shape of the absorbing material part 320 to be formed. Further, the entire material of the mold 340 may be, for example, stainless steel. An NiP plating may be formed on the front surface of the mold 340.

Then, as illustrated in (b) of FIG. 20, a droplet of a light absorbing resin 320a for forming the absorbing material part 320 is applied to the mold 340. The light absorbing resin 320a is formed of a light absorbing material that can be cured by being radiated by ultraviolet (UV) light. The light absorbing resin 320a may include a black material such as black titanium oxide and carbon black.

Then, as illustrated in (c) of FIG. 20, the transparent substrate 110 is mounted on the droplet of the light absorbing resin 320a. The transparent substrate 110 may be, for example, Lumirror U32 (manufactured by Toray Co. Ltd.,) having a thickness of approximately 50 μm.

Then, as illustrated in (d) of FIG. 20, the light absorbing resin 120a is cured by radiating ultraviolet light from the side on which the transparent substrate 110 is mounted. Thereby, the absorbing material part 320 is formed. The ultraviolet light radiated in this step has a wavelength of 365 nm and an illumination power density of 300 mW/cm². The ultraviolet light is radiated for 200 seconds.

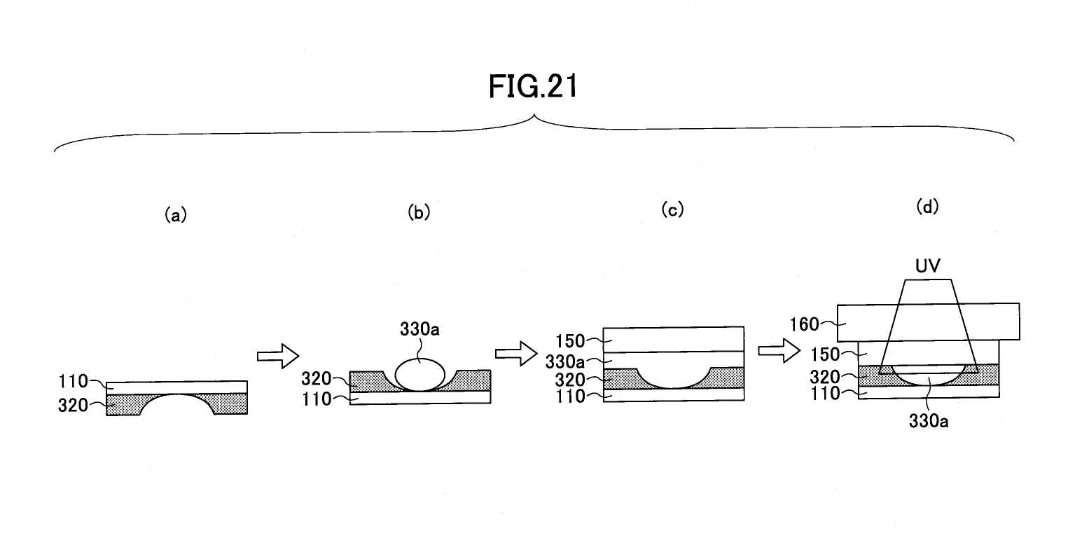

Then, as illustrated in (a) of FIG. 21, the mold 340 is separated from the transparent substrate 110 and the absorbing material part 320. Thereby, the transparent substrate 110 having a concave-shaped absorbing material part 320 formed thereon is obtained. It is to be noted that the absorbing material part 320 includes a light absorbing material such as black titanium oxide or carbon black. The refractive index of the absorbing material part 320 is, for example, 1.60.

Then, as illustrated in (b) of FIG. 21, a droplet of a transparent resin 330a is applied on the concave-shaped portion of the absorbing material part 320. The transparent resin 330a is a resin material that can transmit light and be cured by being radiated with ultraviolet light.

Then, as illustrated in (c) of FIG. 21, a release substrate 150 is mounted on the droplet of the transparent resin 330a. The release substrate 150 is formed of, for example, quartz. The front surface of the release substrate 150 has fluorine applied, so that the release substrate 150 can easily be released in a subsequent process.

Then, as illustrated in (d) of FIG. 21, ultraviolet light is radiated to the transparent resin 330a in a state where pressure is exerted from a press machine having a quartz window 160 by way of the release substrate 150. As for the conditions for this step, the exerted pressure is approximately 0.5 MPa, and the radiated ultraviolet light has a wavelength of 365 nm and an illumination power density of 300 mW/cm². The ultraviolet light is radiated for 30 seconds.

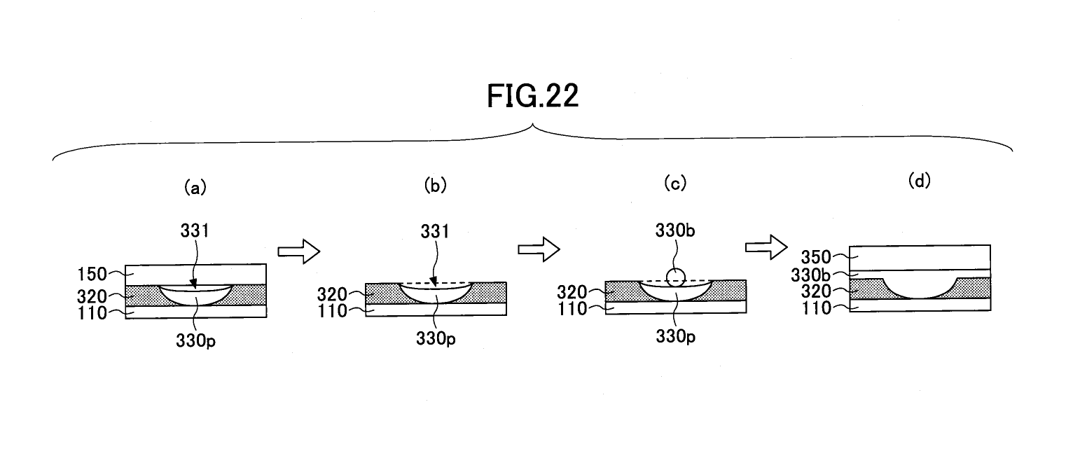

By radiating the ultraviolet light in the state where pressure is exerted, the transparent resin 330a is cured, so that a transparent material part 330p (see (a) of FIG. 22) is formed. Because the transparent resin 330a shrinks during this process, a center portion of the transparent material part 330p becomes recessed in correspondence to the concave shape of the absorbing material part 320. Thereby, the transparent material part 330p is formed having a concave part 331 as illustrated in (a) of FIG. 22.

Then, as illustrated in (b) of FIG. 22, the release substrate 150 is released.

Then, as illustrated in (c) of FIG. 22, a droplet of a transparent resin 330b is applied to the concave part 331 of the front surface of the transparent material part 330p. The transparent resin 330b is the same material as the transparent resin 330a. Thus, the transparent resin 330b is also formed of a light transmitting resin that can be cured by being radiated by ultraviolet (UV) light.

Then, as illustrated in (d) of FIG. 22, a release substrate 350 is mounted on the droplet of the transparent resin 330b. The release substrate 350 is formed of, for example, quartz. The front surface of the release substrate 350 is applied with fluorine, so that the release substrate 350 can easily be released in a subsequent process.

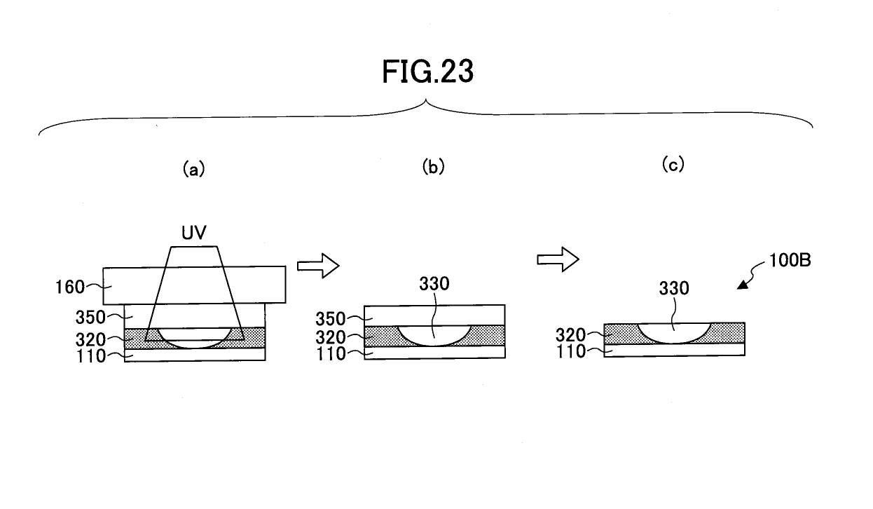

Then, as illustrated in (a) of FIG. 23, the transparent resin 330b is cured by radiating ultraviolet light from the side in which the release substrate 350 is mounted. The ultraviolet light is radiated to the transparent resin 330b in a state where pressure is exerted from a press machine having a quartz window 160 by way of the release substrate 350. As for the conditions for this step, the exerted pressure is approximately 0.5 MPa, the radiated ultraviolet light has a wavelength of 365 nm and an illumination power density of 300 mW/cm². The ultraviolet light is radiated for 30 seconds.

By radiating the ultraviolet light in the state where pressure is exerted, the transparent resin 330b is cured, so that the transparent material part 330 (including the transparent material part 330p) is formed as illustrated in (b) of FIG. 23. In this process, the transparent resin 330b shrinks. However, because the transparent resin 330b is extremely thin, the transparent material part 330, which is formed by curing the transparent resin 330b, can be formed to have a front surface with a flatness of 0.09 μm. The refractive index of the transparent material part 330 is, for example, 1.60.

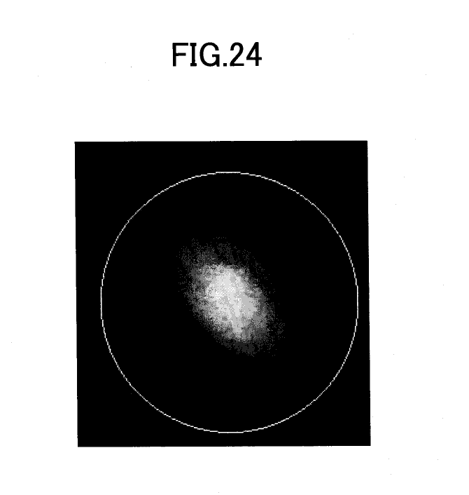

Then, as illustrated in (c) of FIG. 23, the release substrate 350 is released. Thereby, the optical device 100B is fabricated. The thickness of the entire optical device 100B is approximately 80 p.m. The transparent material part 330 is formed to have a substantially flat front surface. The optical device 100B has a transmitted wavefront precision of, for example, 0.25λ relative to light having a wavelength of 405 nm. Thus, as illustrated in FIG. 24, hardly any interference fringes are created with the optical device 100B.

With the third embodiment of the present invention, by forming the transparent material part 330 with an increased number of steps, the transparent material part 330 can be formed having a satisfactory flatness.

Except for the details described above, the third embodiment is substantially the same as the first embodiment. Further, the optical device 100B of the third embodiment can be applied to the imaging apparatus of the first embodiment.

### Fourth Embodiment

Next, an optical device 100C according to a fourth embodiment of the present invention is described. The optical device 100C of the fourth embodiment is substantially the same as the optical device 100B of the third embodiment except that the optical device 100C of the fourth embodiment is formed to be thicker.

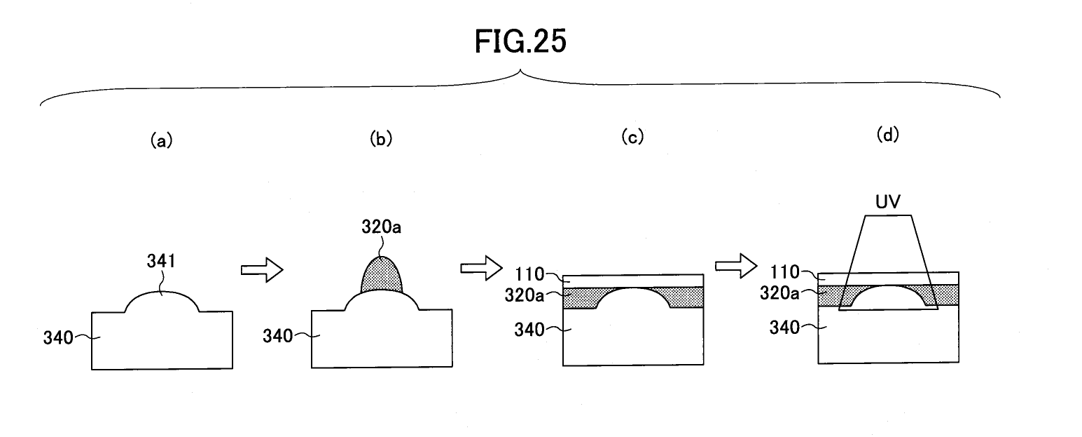

Next, a method for manufacturing the optical device 100C according to the fourth embodiment is described with reference to FIGS. 25 to 27. First, as illustrated in (a) of FIG. 25, a mold 340 for forming the absorbing material part 320 is prepared. A convex part 341 having a height of, for example, 27 μm is formed in a center portion of the mold 340. The convex part 341 has a shape corresponding to the concave shape of the absorbing material part 320 to be formed. Further, the entire material of the mold 340 may be, for example, stainless steel. An NiP plating may be formed on the front surface of the mold 340.

Then, as illustrated in (b) of FIG. 25, a droplet of a light absorbing resin 320a for forming the absorbing material part 320 is applied to the mold 340. The light absorbing resin 320a is formed of a light absorbing material that can be cured by being radiated by ultraviolet (UV) light. The light absorbing resin 320a may include a black material such as black titanium oxide and carbon black.

Then, as illustrated in (c) of FIG. 25, the transparent substrate 110 is mounted on the droplet of the light absorbing resin 320a. The transparent substrate 110 may be, for example, Lumirror U32 (manufactured by Toray Co. Ltd.,) having a thickness of approximately 50 μm.

Then, as illustrated in (d) of FIG. 25, the light absorbing resin 320a is cured by radiating ultraviolet light from the side in which the transparent substrate 110 is mounted. Thereby, the absorbing material part 320 is formed. The ultraviolet light radiated in this step has a wavelength of 365 nm and an illumination power density of 300 mW/cm². The ultraviolet light is radiated for 200 seconds.

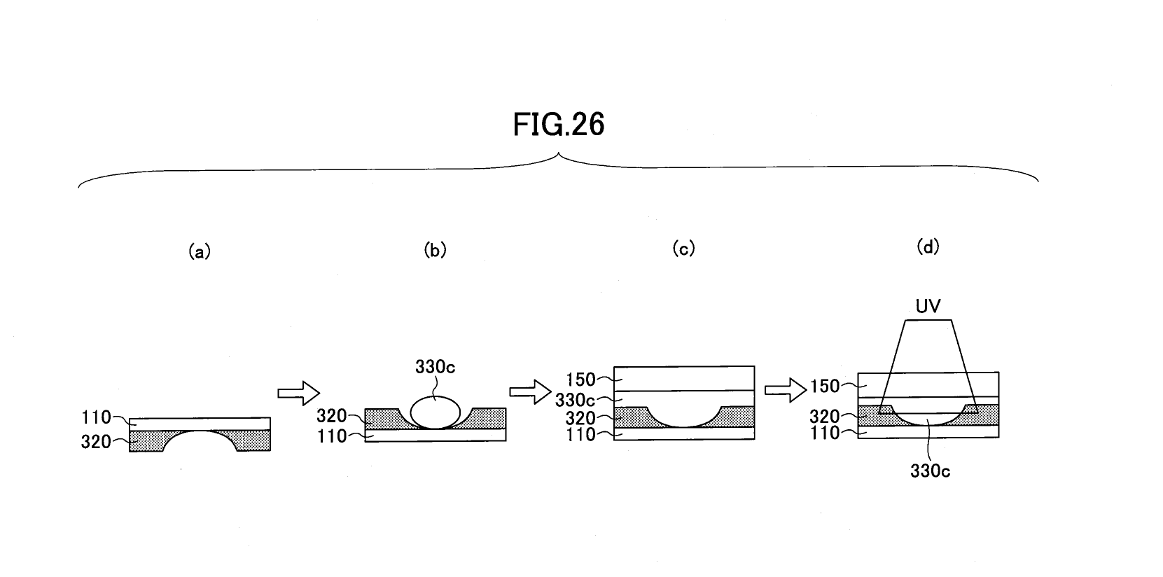

Then, as illustrated in (a) of FIG. 26, the mold 340 is separated from the transparent substrate 110 and the absorbing material part 320. Thereby, the transparent substrate 110 having a concave-shaped absorbing material part 320 formed thereon is obtained. It is to be noted that the absorbing material part 320 includes a light absorbing material such as black titanium oxide or carbon black. The refractive index of the absorbing material part 320 is, for example, 1.60.

Then, as illustrated in (b) of FIG. 26, a droplet of a transparent resin 330c is applied on the concave-shaped portion of the absorbing material part 320. The transparent resin 330c is a resin material that can transmit light and be cured by being radiated with ultraviolet light.

Then, as illustrated in (c) of FIG. 26, a release substrate 150 is mounted on the droplet of the transparent resin 330c. The release substrate 150 is formed of, for example, quartz. The front surface of the release substrate 150 is applied with fluorine, so that the release substrate 150 can easily be released in a subsequent process.

Then, as illustrated in (d) of FIG. 26, the transparent resin 330c is cured by radiating ultraviolet light from the side in which the release substrate 150 is mounted. Thereby, the transparent material part 330 is formed. The ultraviolet light radiated in this step has a wavelength of 365 nm and an illumination power density of 5 mW/cm². The ultraviolet light is radiated for 30 minutes.

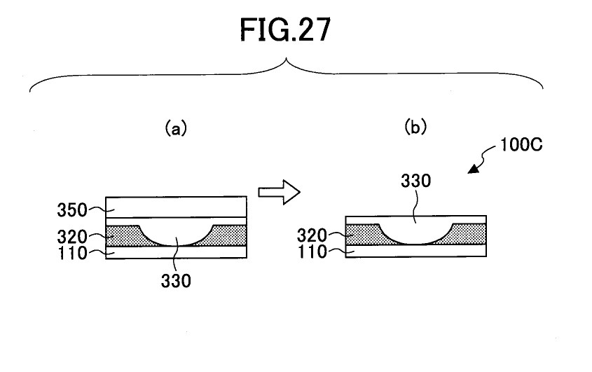

Accordingly, because the transparent resin 330c is cured slowly by radiating ultraviolet light with a low illumination power density for a long time, the transparent resin 330c is able to flow during the curing process. Thereby, even in a case where a shrunken area such as a recess is created in the curing process, the transparent resin 330c can flow into the shrunken area. Thus, as illustrated in (a) of FIG. 27, the transparent material part 330, which is formed by curing the transparent resin 330c, can be formed to have a substantially flat front surface.

Then, as illustrated in (b) of FIG. 27, the release substrate 350 is released. Thereby, the optical device 100C is fabricated. The optical device 100C can be formed to have an entire thickness of approximately greater than or equal to 200 μm. Further, the optical device 100C can be formed to have a substantially flat front surface.

Except for the details described above, the fourth embodiment is substantially the same as the first embodiment. Further, the optical device 100C of the fourth embodiment can be applied to the imaging apparatus of the first embodiment.

### Fifth Embodiment

Next, an optical apparatus 2000 according to a fifth embodiment of the present invention is described. The optical apparatus 2000 uses at least one of the optical devices 100, 100A, 100B, and 100C of first-fourth embodiments. The optical apparatus 2000 is mounted in a portable electronic device having a communication function such as a smartphone or a mobile phone. The optical apparatus 2000 includes the imaging device 1000 of the first embodiment illustrated in FIG. 14. In the below-described embodiment, the optical apparatus 2000 is mounted in a smartphone 410.

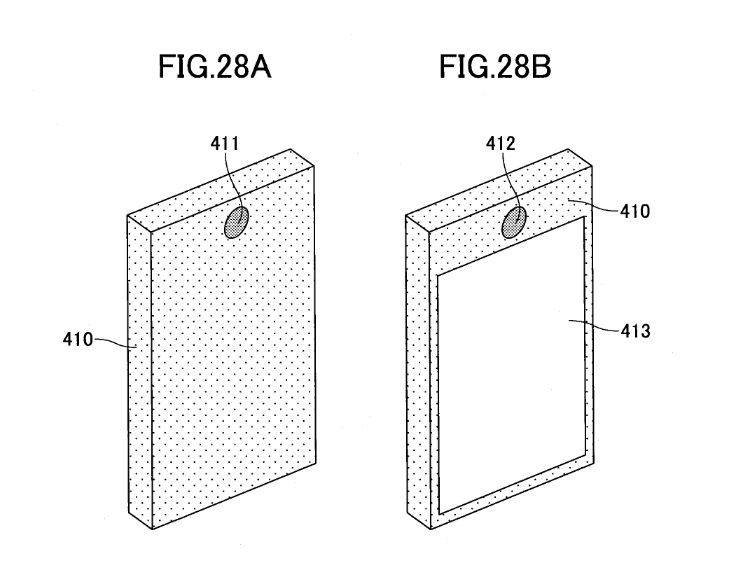

More specifically, as illustrated in FIGS. 28A and 28B, the optical apparatus 2000 may be a main camera 411 and/or a sub-camera 412 mounted in the smartphone 410. In this embodiment, the main camera 411 is mounted on a side of the smartphone 410 that is opposite from the side in which a display screen 413 is provided. The sub-camera 412 is mounted on the same side as the display screen 413. FIG. 28A is a perspective view illustrating a back side of the smartphone 410. FIG. 28B is a perspective view illustrating a front side of the smartphone 410 in which the display screen 413.

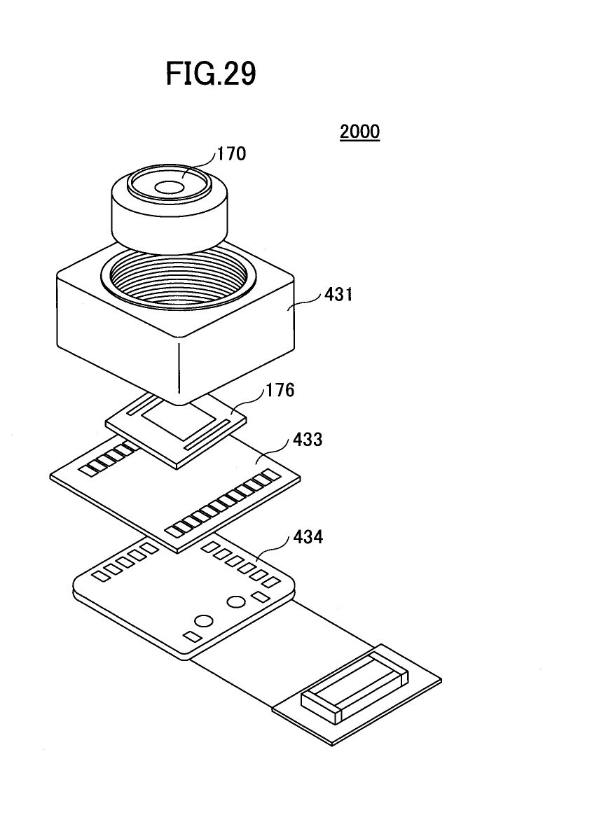

As illustrated in FIG. 29, the optical apparatus 2000 such as the main camera 411 and the sub-camera 412 may include, for example, an optical system 170, an autofocus unit 431, an imaging device (e.g., image sensor) 176, a substrate 433, and a flexible substrate 434. The optical system 170 is mounted in the autofocus unit 431. The autofocus unit 431 controls the movement of the optical system 170 to enable an autofocusing movement. The imaging device 176 such as an image sensor is formed of a CMOS (Complementary Metal Oxide Semiconductor) sensor. The imaging device 176 detects an image formed by incident light via the optical system 170.

Further, the present invention is not limited to these embodiments, but variations and modifications may be made without departing from the scope of the present invention.

1. An optical device for monotonously reducing light transmittance from a center portion thereof to a peripheral portion thereof, the optical device comprising:
an absorbing material part formed of a material that can absorb light and having a thickness monotonously increasing from the center portion to the peripheral portion; and
a transparent material part formed of a material that can transmit light and stacked on the absorbing material part;
wherein a value of a refractive index of the absorbing material part and a value of a refractive index of the transparent material part are different.

2. The optical device as claimed in claim 1,
wherein an expression “0.018−λ/2D<|N₁−N₂|<0.06+λ/2D” is satisfied
in a case where “D” represents a thickness of a thickest part of the absorbing material part, “N₁” represents the refractive index of the absorbing material part, and “N₂” represents the refractive index of the transparent material part, “λ” is 405 nm, and
wherein “15 μm<D<50 μm” is satisfied.

3. The optical device as claimed in claim 1,
wherein the absorbing material part and the transparent material part are formed of a photo-polymerizable organic material or a thermally polymerizable organic material.

4. The optical device as claimed in claim 2,
wherein the absorbing material part and the transparent material part are formed of a photo-polymerizable organic material or a thermally polymerizable organic material.

5. An optical apparatus comprising:
the optical device of claim 1;
a lens on which the light is incident; and
an imaging device that detects an image formed by the light incident on the lens.

6. An optical apparatus comprising:
the optical device of claim 2;
a lens on which the light is incident; and
an imaging device that detects an image formed by the light incident on the lens.

7. An optical apparatus comprising:
the optical device of claim 3;
a lens on which the light is incident; and
an imaging device that detects an image formed by the light incident on the lens.

8. An optical apparatus comprising:
the optical device of claim 4;
a lens on which the light is incident; and
an imaging device that detects an image formed by the light incident on the lens.

9. The optical apparatus as claimed in claim 5,
wherein the optical apparatus is configured to be mounted in a portable electronic device having a communication function.

10. The optical apparatus as claimed in claim 6,
wherein the optical apparatus is configured to be mounted in a portable electronic device having a communication function.

11. The optical apparatus as claimed in claim 7,
wherein the optical apparatus is configured to be mounted in a portable electronic device having a communication function.

12. The optical apparatus as claimed in claim 8,
wherein the optical apparatus is configured to be mounted in a portable electronic device having a communication function.

13. The optical apparatus as claimed in claim 9,
wherein the optical apparatus is configured to be mounted in a portable electronic device having a communication function.

14. A method for manufacturing an optical device, comprising the steps of:
forming an absorbing material part including a concave part by applying a droplet of a light absorbing resin in a mold having a convex-shaped center portion and curing the light absorbing resin; and
forming a transparent material part in the concave part by applying a droplet of a transparent resin to the concave part and curing the transparent resin;
wherein the absorbing material part and the transparent material part are formed of a photo-polymerizable organic material or a thermally polymerizable organic material, and
wherein a refractive index of the transparent material part is higher than a refractive index of the absorbing material part.

15. The method as claimed in claim 14,
wherein the step of forming the absorbing material part includes
mounting a transparent substrate on the light absorbing resin after applying the droplet of the light absorbing resin, and
curing the light absorbing resin after mounting the transparent substrate.

16. A method for manufacturing an optical device, comprising the steps of:
forming a transparent material part by applying a droplet of a transparent resin in a mold having a concave-shaped center portion and curing the transparent resin; and
forming an absorbing material part by applying a droplet of a light absorbing resin onto the transparent material part and curing the light absorbing resin;
wherein the absorbing material part and the transparent material part are formed of a photo-polymerizable organic material or a thermally polymerizable organic material, and
wherein a refractive index of the transparent material part is lower than a refractive index of the absorbing material part.

17. The method as claimed in claim 16,
wherein the step of forming the transparent material part includes
mounting a transparent substrate on the transparent resin after applying the droplet of the transparent resin, and
curing the transparent resin after mounting the transparent substrate.
